(19) United States
(12) Patent Application Publication
(10) Pub. No.: US 2011/0143556 A1
(43) Pub. Date: Jun. 16, 2011

(54) CONNECTING MECHANISM FOR CONNECTING POWER ADAPTER AND ELECTRONIC DEVICE

(75) Inventor: Jui-Yuan Hsu, Taoyuan Hsien (TW)

(73) Assignee: DELTA ELETRONICS, INC., Taoyuan Hsien (TW)

(21) Appl. No.: 12/963,584

(22) Filed: Dec. 8, 2010

(30) Foreign Application Priority Data
Dec. 10, 2009 (TW) 098142345

(51) Int. Cl. H01R 11/30

(52) U.S. Cl. 439/39

(57) ABSTRACT

A connecting mechanism is provided for connecting a power adapter and an electronic device. The connecting mechanism includes a first connecting part and a second connecting part. The first connecting part is connected with the power adapter, and includes a first magnetic core, a first winding and a first magnetic element. The second connecting part is connected with the electronic device, and includes a second magnetic core, a second winding and a second magnetic element. The first magnetic element and the second magnetic element are aligned with and magnetically attracted by each other, so that the first connecting part is fixed onto the second connecting part and electromagnetic coupling between the first winding and the second winding is produced.

### CLAIM OF PRIORITY

This application claims priority to Taiwanese Patent Application No. 098142345 filed on Dec. 10, 2009.

### FIELD OF THE INVENTION

The present invention relates to a connecting mechanism, and more particularly to a connecting mechanism for connecting a power adapter and an electronic device.

### BACKGROUND OF THE INVENTION

An electronic device such as a notebook computer is usually equipped with a power adapter to be connected with an external power source (e.g. a utility power source). Through the power adapter, electricity could be transmitted from the external power source to the electronic device.

Conventionally, the power adapter has a male connector (e.g. a plug), and the electronic device has a female connector (e.g. a DC Jack socket). After the male connector is inserted into the female connector, the friction between the male connector and the female connector allows these two connectors to be securely connected with each other. Since the plug is only allowed to be inserted into the socket in a specified direction, the utilization is limited. In addition, since the plug is allowed to be withdrawn from the socket in the specified direction and the plug and the socket are securely connected with each other, the plug fails to be detached from the socket when the pulling direction is improper or the pulling force is insufficient. For example, if the power cable of the power adapter is carelessly pulled by the user, the electronic device is also pulled because the power adapter is still coupled with the electronic device. In this situation, the electronic device may fall down and be damaged. Moreover, the plug and the socket have exposed metallic terminals. If the exposed metallic terminals are in contact with an external conductor, a short-circuited problem occurs.

Therefore, there is a need of providing an improved connecting mechanism for connecting a power adapter and an electronic device so as to obviate the drawbacks encountered from the prior art.

### SUMMARY OF THE INVENTION

It is an object of the present invention to provide a connecting mechanism for connecting a power adapter and an electronic device in order to reduce the possibility of falling down or damaging the electronic device when the power cable of the power adapter is carelessly pulled by the user.

Another object of the present invention provides a connecting mechanism for connecting a power adapter and an electronic device in order to avoid the short-circuited problem.

In accordance with an aspect of the present invention, there is provided a connecting mechanism for connecting a power adapter and an electronic device. The connecting mechanism includes a first connecting part and a second connecting part. The first connecting part is connected with the power adapter, and includes a first magnetic core, a first winding and a first magnetic element. The second connecting part is connected with the electronic device, and includes a second magnetic core, a second winding and a second magnetic element. The first magnetic element and the second magnetic element are aligned with and magnetically attracted by each other, so that the first connecting part is fixed onto the second connecting part and electromagnetic coupling between the first winding and the second winding is produced.

In accordance with another aspect of the present invention, there is provided a connecting mechanism for connecting a power adapter and an electronic device. The connecting mechanism includes a first connecting part and a second connecting part. The first connecting part is connected with the power adapter, and includes a first insulating enclosure and a first magnetic element. The first magnetic element is disposed on the first insulating enclosure. The second connecting part is connected with the electronic device, and includes a second insulating enclosure and a second magnetic element. The second magnetic element is disposed on the second insulating enclosure. The first magnetic element and the second magnetic element are magnetically attracted by each other, so that the first connecting part is fixed onto the second connecting part.

The above contents of the present invention will become more readily apparent to those ordinarily skilled in the art after reviewing the following detailed description and accompanying drawings, in which:

### BRIEF DESCRIPTION OF THE DRAWINGS

FIG. 1A is a schematic view illustrating the connection between a power adapter and an electronic device according to a first embodiment of the present invention;

FIG. 1B is a schematic view illustrating the connecting mechanism of FIG. 1A;

FIG. 1C is a schematic circuit diagram illustrating occurrence of the electromagnetic coupling between the first magnetic core and the second magnetic core of the connecting mechanism of the present invention;

FIG. 2A is a schematic view illustrating the connection between a power adapter and an electronic device according to a second embodiment of the present invention;

FIG. 2B is a schematic view illustrating the connecting mechanism of FIG. 2A;

FIG. 2C is a schematic view illustrating a variant of the connecting mechanism of FIG. 2A; and

FIG. 2D is a schematic view illustrating another variant of the connecting mechanism of FIG. 2A.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

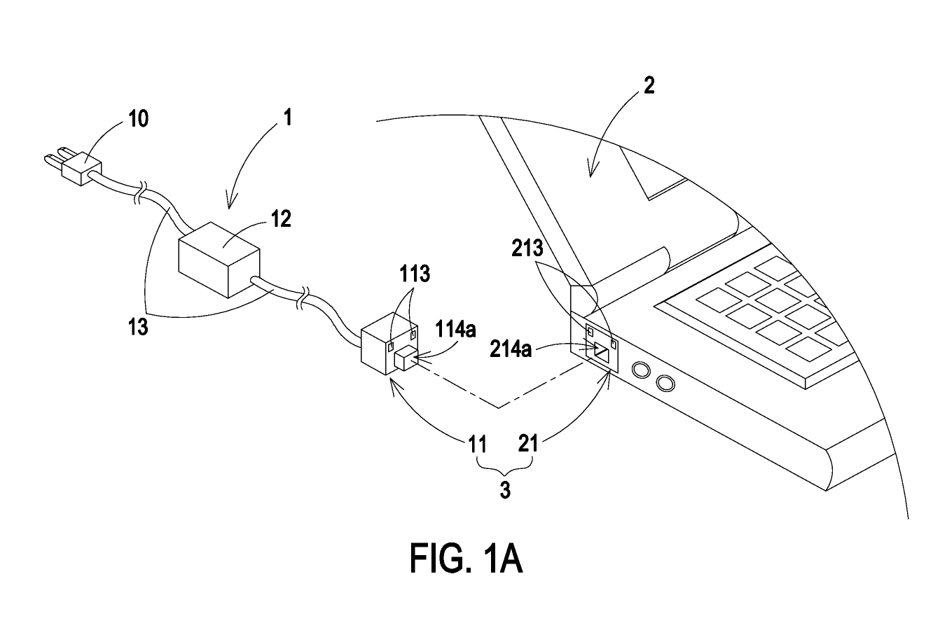

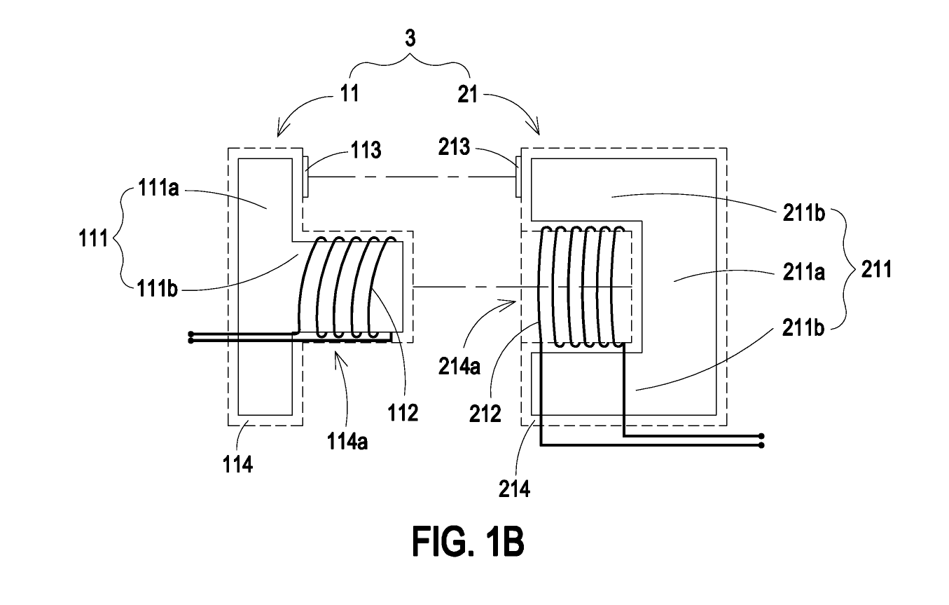

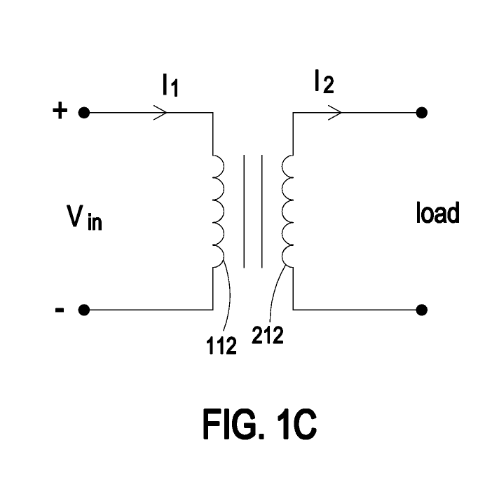

FIG. 1A is a schematic view illustrating the connection between a power adapter and an electronic device according to a first embodiment of the present invention. FIG. 1B is a schematic view illustrating the connecting mechanism of FIG. 1A. The power adapter 1 is connected with the electronic device 2 through a connecting mechanism 3. The connecting mechanism 3 comprises a first connecting part 11 and a second connecting part 21. The first connecting part 11 is connected with the power adapter 1. The first connecting part 11 comprises a first magnetic core 111, a first winding 112 and a first magnetic element 113. The second connecting part 21 is disposed on the electronic device 2. The second connecting part 21 comprises a second magnetic core 211, a second winding 212 and a second magnetic element 213. The first magnetic element 113 and the second magnetic element 213 are aligned with and magnetically attracted by each other, so that the first connecting part 11 could be fixed onto the second connecting part 21. In this situation, electromagnetic coupling is produced between the second winding 212 of the second connecting part 21 and the first winding 112 of the first connecting part 11.

The first connecting part 11 is connected to a first end of a main body 12 of the power adapter 1 through a power cable 13. A second end of the main body 12 of the power adapter 1 is connected to a power input terminal 10 through the power cable 13. When the power input terminal 10 is connected to an external power source (e.g. a utility power source), electricity could be transmitted from the power adapter 1 to the electronic device 2 through the first connecting part 11 and the second connecting part 21.

The first magnetic core 111 of the first connecting part 11 comprises a first slab 111a and a center leg 111b. It is preferred that the first slab 111a and the center leg 111b are integrally formed. The center leg 111b is vertically extended from a middle portion of the first slab 111a. The first winding 112 is a conductive coil wound around the center leg 111b of the first magnetic core 111. The turn number of the first winding 112 is selected according to the practical requirements. The first connecting part 11 further comprises a first insulating enclosure 114. The first magnetic core 111 and the first winding 112 are encapsulated within the first insulating enclosure 114, so that the first magnetic core 111 and the first winding 112 are isolated from the surroundings. Corresponding to the center leg 111b and the first winding 112 wound around the center leg 111b, the first insulating enclosure 114 has a convex structure 114a. The first magnetic element 113 is disposed on the first insulating enclosure 114 and faces the second magnetic element 213. By the first insulating enclosure 114, the first magnetic element 113 is isolated from the first magnetic core 111 and the first winding 112. As such, the attractive ability of the first magnetic element 113 is not interfered by the first magnetic core 111 and the first winding 112.

Please refer to FIGS. 1A and 1B again. The second connecting part 21 of the connecting mechanism 3 is disposed on a sidewall of the electronic device 2 in order to be connected with the first connecting part 11. An example of the electronic device 2 includes but is not limited to a notebook computer or other portable electronic device. The second magnetic core 211 of the second connecting part 21 comprises a second slab 211a and two lateral legs 211b. The lateral legs 211b are vertically extended from edges of the second slab 211a. It is preferred that the second slab 211a and the lateral legs 211b are integrally formed. The second winding 212 is wound to a ring-shaped winding, and disposed between the lateral legs 211b. In other words, the second winding 212 is received with a receptacle defined by the lateral legs 211b and the second slab 211a of the second magnetic core 211. Similarly, the second connecting part 21 further comprises a second insulating enclosure 214. The second magnetic core 211 and the second winding 212 are encapsulated within the second insulating enclosure 214, so that the second magnetic core 211 and the second winding 212 are isolated from the surroundings. Corresponding to the lateral legs 211b and the second winding 212, the second insulating enclosure 214 has a concave structure 214a. The concave structure 214a of the second insulating enclosure 214 is fitted with the convex structure 114a of the first insulating enclosure 114 of the first connecting part 11. In other words, the dimension of the concave structure 214a conforms to the dimension of the convex structure 114a. When the first connecting part 11 and the second connecting part 21 are combined together, the convex structure 114a is accommodated within the concave structure 214a. The second magnetic element 213 is disposed on the second insulating enclosure 214 and aligned with the first magnetic element 113 of the first connecting part 11.

In this embodiment, the first insulating enclosure 114 and the second insulating enclosure 214 are produced by a plastic injection molding process. Alternatively, the first insulating enclosure 114 is an insulating article for encapsulating the first magnetic core 111 and the first winding 112; and the second insulating enclosure 214 is another insulating article for encapsulating the second magnetic core 211 and the second winding 212. For clearly illustrating the first connector 11 and the second connector 21, the first insulating enclosure 114 and the second insulating enclosure 214 are indicated as dotted lines in FIG. 1B.

In an embodiment, the first magnetic element 113 and the second magnetic element 213 are made of permanent magnetic material. For example, the first magnetic element 113 and the second magnetic element 213 are permanent magnets. Alternatively, one of the first magnetic element 113 and the second magnetic element 213 is a permanent magnet, and the other of the first magnetic element 113 and the second magnetic element 213 is made of a ferromagnetic material such as iron, cobalt, nickel, or alloy thereof. The numbers of the first magnetic element 113 and the second magnetic element 213 are not restricted as long as the first magnetic element 113 and the second magnetic element 213 are magnetically attracted by each other.

Please refer to FIGS. 1A and 1B again. For connecting the first connecting part 11 with the second connecting part 21, the convex structure 114a and the concave structure 214a are aligned with each other while the first magnetic element 113 and the second magnetic element 213 are aligned with each other. After the convex structure 114a is accommodated within the concave structure 214a and the first magnetic element 113 and the second magnetic element 213 are magnetically attracted by each other, the first connecting part 11 and the second connecting part 21 are connected with each other. Moreover, the center leg 111b and the first winding 112 are encapsulated by the convex structure 114a of the first insulating enclosure 114, and the lateral legs 211b and the second winding 212 are encapsulated by the second insulating enclosure 214 and beside the concave structure 214a. As such, after the convex structure 114a is accommodated within the concave structure 214a, the second winding 212 of the second connecting part 21 is substantially sheathed around the first winding 112 of the first connecting part 11. Meanwhile, a closed magnetic path is defined by the first magnetic core 111 and the second magnetic core 211, so that electromagnetic coupling between the first winding 112 and the second winding 212 is produced.

FIG. 1C is a schematic circuit diagram illustrating occurrence of the electromagnetic coupling between the first magnetic core and the second magnetic core of the connecting mechanism of the present invention. When the power input terminal 10 is connected to an external power source (e.g. a utility power source), a first current I1 flows through the first winding 112 of the first connecting part 11. Due to magnetic induction, the second winding 212 of the second connecting part 21 generates a second current I2, thereby powering the electronic device 2. In other words, electricity could be transmitted from the external power source to the electronic device 2 by means of the electromagnetic coupling between the first magnetic core 111 and the second magnetic core 211.

The turn numbers of the first winding 112 and the second winding 212 may be varied according to the practical requirements. Moreover, the distance between the first winding 112 and the second winding 212 may be adjusted by changing the thickness of the first insulating enclosure 114 and/or the second insulating enclosure 214. As a consequence, the conductance of the connecting mechanism 3 is adjusted, and a desired magnitude of the second current I2 is acquired.

From the above discussion, after the first magnetic element 113 and the second magnetic element 213 are magnetically attracted by each other, the first connecting part 11 and the second connecting part 21 are connected with each other. In comparison with the prior art, the first connecting part 11 and the second connecting part 21 no longer need to be precisely aligned with each other because the magnetically attracting means is very simple. Moreover, if the power cable of the power adapter is carelessly pulled by the user, the first connecting part 11 and the second connecting part 21 may be detached from each other. As a consequence, the possibility of falling down or damaging the electronic device is minimized. Moreover, the first magnetic element 113 and the second magnetic element 213 are respectively disposed on the outer surfaces of the first insulating enclosure 114 and the second insulating enclosure 214, and the first magnetic core 111 and the second magnetic core 211 are respectively encapsulated by the first insulating enclosure 114 and the second insulating enclosure 214. As such, even if any foreign metallic element (e.g. a paper clip, a staple or a craft knife) is attracted by the first magnetic element 113 and/or the second magnetic element 213, the possibility of causing the short-circuited problem is minimized.

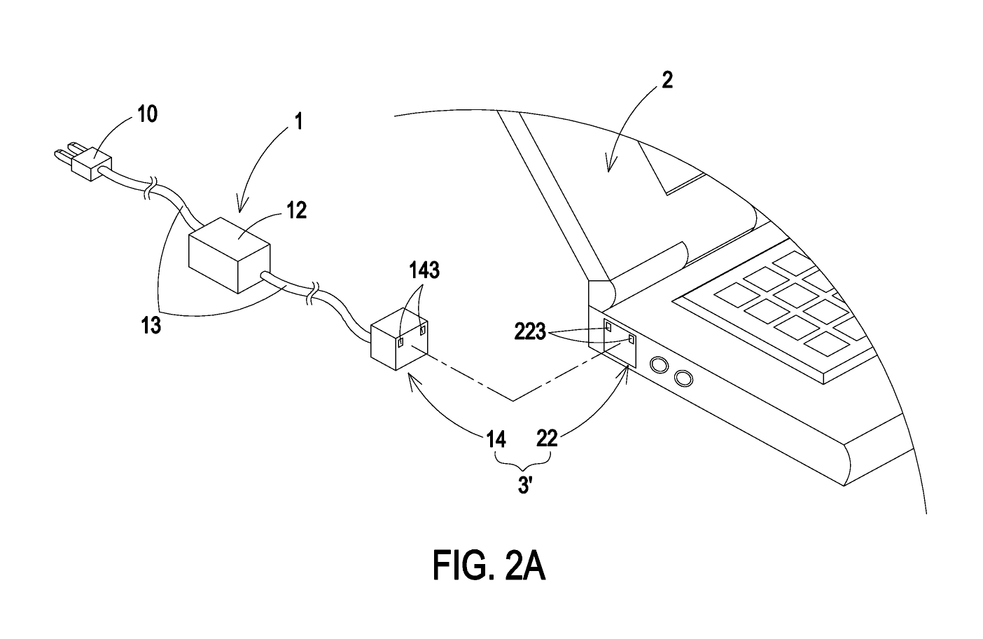

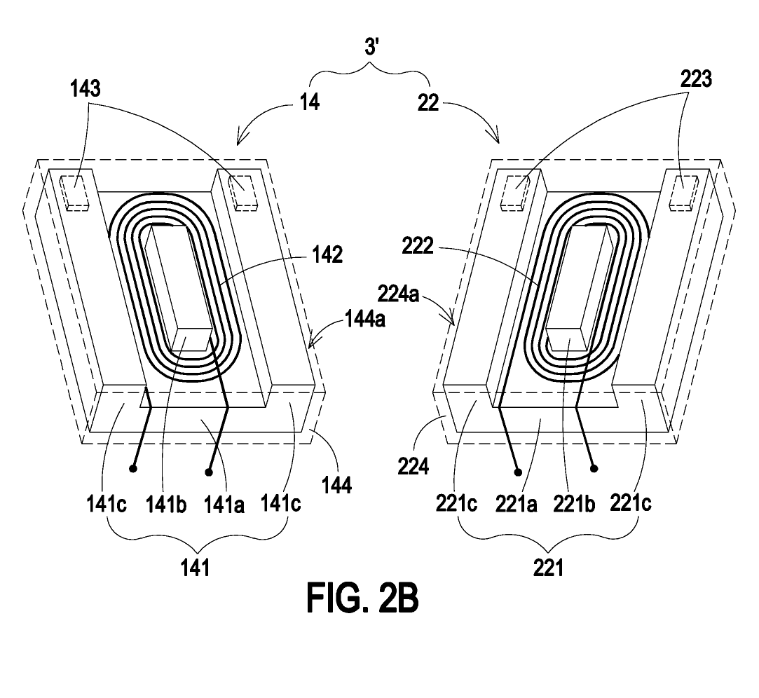

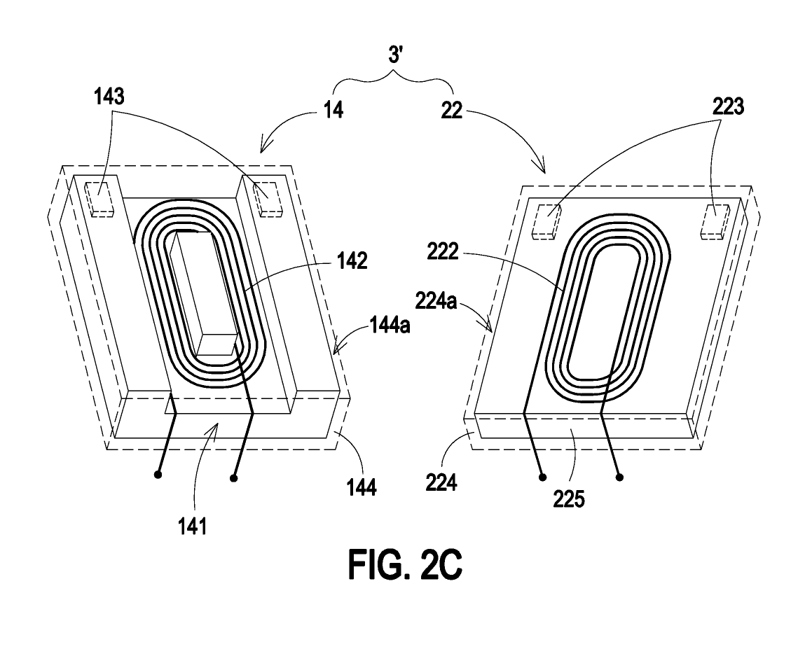

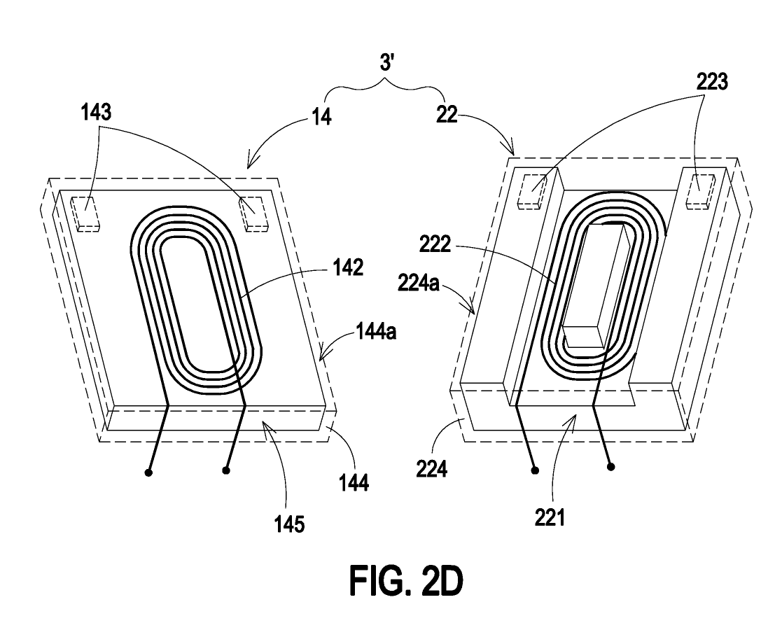

FIG. 2A is a schematic view illustrating the connection between a power adapter and an electronic device according to a second embodiment of the present invention. The power adapter 1 is connected with the electronic device 2 through a connecting mechanism 3′. The connecting mechanism 3′ comprises a first connecting part 14 and a second connecting part 22. The first connecting part 14 is connected to a first end of a main body 12 of the power adapter 1 through a power cable 13. A second end of the main body 12 of the power adapter 1 is connected to a power input terminal 10 through the power cable 13. The second connecting part 22 is disposed on the electronic device 2.

FIG. 2B is a schematic view illustrating the connecting mechanism of FIG. 2A. As shown in FIG. 2B, the first connecting part 14 comprises a first magnetic core 141, a first winding 142 and a first magnetic element 143. The first magnetic core 141 of the first connecting part 14 comprises a first slab 141a, a first center leg 141b and two first lateral legs 141c. The first center leg 141b is vertically extended from a middle portion of the first slab 141a. The first lateral legs 141c are vertically extended from two opposite edge portions of the first slab 141a. In other words, the first magnetic core 141 is substantially an integral E-shaped magnetic core. Moreover, a gap is defined between the first center leg 141b and each first lateral leg 141c. The first winding 142 is a coil pancake lying flat on the first slab 141a and arranged between the first center leg 141b and the first lateral legs 141c. The first connecting part 14 further comprises a first insulating enclosure 144. The first magnetic core 141 and the first winding 142 are encapsulated within the first insulating enclosure 144, so that the first magnetic core 141 and the first winding 142 are isolated from the surroundings. The first insulating enclosure 144 has a first surface 144a for sheltering the first center leg 141b, the first lateral legs 141c and the first winding 142. The first magnetic element 143 is disposed on the first surface 144a of the first insulating enclosure 144. For clearly illustrating the first connector 14, the first insulating enclosure 144 and the first magnetic element 143 are indicated as dotted lines in FIG. 2B.

Please refer to FIG. 2B again. The second connecting part 22 comprises a second magnetic core 221, a second winding 222 and a second magnetic element 223. The second magnetic core 221 of the second connecting part 22 comprises a second slab 221a, a second center leg 221b and two second lateral legs 221c. The second center leg 221b is vertically extended from a middle portion of the second slab 221a. The second lateral legs 221c are vertically extended from two opposite edge portions of the second slab 221a. In other words, the second magnetic core 221 is substantially an integral E-shaped magnetic core. The second winding 222 is a coil pancake lying flat on the second slab 221a and arranged between the second center leg 221b and the second lateral legs 221c. The second connecting part 22 further comprises a second insulating enclosure 224. The second magnetic core 221 and the second winding 222 are encapsulated within the second insulating enclosure 224, so that the second magnetic core 221 and the second winding 222 are isolated from the surroundings. The second insulating enclosure 224 has a second surface 224a for sheltering the second center leg 221b, the second lateral legs 221c and the second winding 222. The second magnetic element 223 is disposed on the second surface 224a of the second insulating enclosure 224, and aligned with the first magnetic element 143. For clearly illustrating the second connector 22, the second insulating enclosure 224 and the second magnetic element 223 are indicated as dotted lines in FIG. 2B.

In this embodiment, the first insulating enclosure 144 and the second insulating enclosure 244 are produced by a plastic injection molding process. In an embodiment, the first magnetic element 143 and the second magnetic element 223 are made of permanent magnetic material. Alternatively, one of the first magnetic element 143 and the second magnetic element 223 is a permanent magnet, and the other of the first magnetic element 143 and the second magnetic element 223 is made of a ferromagnetic material such as iron, cobalt, nickel, or alloy thereof. The numbers of the first magnetic element 143 and the second magnetic element 223 are not restricted as long as the first magnetic element 113 and the second magnetic element 213 are magnetically attracted by each other.

Please refer to FIGS. 2A and 2B again. For connecting the first connecting part 14 with the second connecting part 22, the first surface 144a of the first connecting part 14 and the second surface 224a of the second connecting part 22 are aligned with each other while the first magnetic element 143 and the second magnetic element 223 are aligned with each other. Since the first magnetic element 143 and the second magnetic element 223 are magnetically attracted by each other, the first connecting part 14 and the second connecting part 22 are connected with each other. Moreover, the first magnetic core 141 and the first winding 142 are encapsulated by the first insulating enclosure 144, and the second magnetic core 221 and the second winding 222 are encapsulated by the second insulating enclosure 224. As such, after the first surface 144a and the second surface 224a are contacted with each other and the first connecting part 14 and the second connecting part 22 are connected with each other, a closed magnetic path is defined by the first magnetic core 141 and the second magnetic core 221, so that electromagnetic coupling between the first winding 142 and the second winding 222 is produced.

Similarly, as shown in FIG. 1C, when the power input terminal 10 is connected to the external power source (e.g. a utility power source), a first current I1 flows through the first winding 142 of the first connecting part 14. Due to magnetic induction, the second winding 222 of the second connecting part 22 generates a second current I2, thereby powering the electronic device 2.

It is noted that, however, those skilled in the art will readily observe that numerous modifications and alterations may be made while retaining the teachings of the invention.

FIG. 2C is a schematic view illustrating a variant of the connecting mechanism of FIG. 2A. As shown in FIG. 2C, the first connecting part 14 comprises a first magnetic core 141, a first winding 142, a first magnetic element 143 and first insulating enclosure 144. The configurations of the first connecting part 14 are similar to those of FIG. 2B, and are not redundantly described herein. The second connecting part 22 comprises a second magnetic core 225, a second winding 222, a second magnetic element 223 and a second insulating enclosure 224. In this embodiment, the second magnetic core 225 is a slab. In other words, the second magnetic core 225 is substantially an I-shaped magnetic core. The second winding 222 is a coil pancake lying flat on the second magnetic core 225. The second magnetic core 225 and the second winding 222 are encapsulated within the second insulating enclosure 224, so that the second magnetic core 225 and the second winding 222 are isolated from the surroundings. The second insulating enclosure 224 has a second surface 224a for sheltering the second magnetic core 225 and the second winding 222. The second magnetic element 223 is disposed on the second surface 224a of the second insulating enclosure 224, and aligned with the first magnetic element 143. For connecting the first connecting part 14 with the second connecting part 22, the first surface 144a of the first connecting part 14 and the second surface 224a of the second connecting part 22 are contacted with each other while the first magnetic element 143 and the second magnetic element 223 are aligned with each other.

FIG. 2D is a schematic view illustrating another variant of the connecting mechanism of FIG. 2A. In this embodiment, the first magnetic core 145 of the first connecting part 14 is substantially an I-shaped magnetic core. The first winding 142 is a coil pancake lying flat on the first magnetic core 145. The first insulating enclosure 144 has a first surface 144a for sheltering the first magnetic core 145 and the first winding 142. The first magnetic element 143 is disposed on the first surface 144a. The configurations of the second connecting part 22 are similar to those of FIG. 2B, and are not redundantly described herein.

In the above embodiments, the first magnetic core of the first connecting part and the second magnetic core of the second connecting part are not restricted. The turn numbers of the first winding and the second winding may be varied according to the practical requirements. The first connecting part and the second connecting part have square profiles. The profiles of the first connecting part and the second connecting part may be varied according to the practical requirements. As the first magnetic core and the second magnetic core are changed, the profiles of the first connecting part and the second connecting part are correspondingly changed. The connecting mechanism of present invention is not restricted as long as the first connecting part and the second connecting part are magnetically attracted by each other and electromagnetic coupling is produced between the first connecting part and the second connecting part to transmit electricity from the power adapter to the electronic device.

From the above description, the connecting mechanism of present invention includes a first connecting part and a second connecting part. When the first magnetic element of the first connecting part and the second magnetic element of the second connecting part are magnetically attracted by each other, the first connecting part and the second connecting part are connected with each other. Due to magnetic induction, when a first current flows through the first winding of the first connecting part, the second winding of the second connecting part generates a second current, thereby powering the electronic device.

In comparison with the prior art, the first connecting part and the second connecting part no longer need to be precisely aligned with each other because the magnetically attracting means is very simple. Moreover, if the power cable of the power adapter is carelessly pulled by the user, the first connecting part and the second connecting part may be detached from each other. As a consequence, the possibility of falling down or damaging the electronic device is minimized. Moreover, the first magnetic element and the second magnetic element are respectively disposed on the outer surfaces of the first insulating enclosure and the second insulating enclosure, and the first magnetic core and the second magnetic core are respectively encapsulated by the first insulating enclosure and the second insulating enclosure. As such, even if any foreign metallic element is attracted by the first magnetic element and/or the second magnetic element, the possibility of causing the short-circuited problem is minimized.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A connecting mechanism for connecting a power adapter and an electronic device, said connecting mechanism comprising:
a first connecting part connected with said power adapter, and comprising a first magnetic core, a first winding and a first magnetic element; and
a second connecting part connected with said electronic device, and comprising a second magnetic core, a second winding and a second magnetic element,
wherein said first magnetic element and the second magnetic element are aligned with and magnetically attracted by each other, so that said first connecting part is fixed onto said second connecting part and electromagnetic coupling between said first winding and said second winding is produced.

2. The connecting mechanism according to claim 1 wherein said first connecting part further comprises a first insulating enclosure for encapsulating said first magnetic core and said first winding, and said second connecting part further comprises a second insulating enclosure for encapsulating said second magnetic core and said second winding.

3. The connecting mechanism according to claim 2 wherein said first insulating enclosure of said first connecting part and said second insulating enclosure of said second connecting part are produced by a plastic injection molding process.

4. The connecting mechanism according to claim 2 wherein said first magnetic element is disposed on said first insulating enclosure, and said second magnetic element is disposed on said second insulating enclosure.

5. The connecting mechanism according to claim 2 wherein said first insulating enclosure has a convex structure, and said second insulating enclosure has a concave structure for accommodating said convex structure.

6. The connecting mechanism according to claim 5 wherein said first magnetic core of said first connecting part comprises a first slab and a center leg, said center leg is vertically extended from a middle portion of said first slab, said first winding is wound around said center leg, and said center leg and said first winding are encapsulated by said convex structure of said first insulating enclosure.

7. The connecting mechanism according to claim 5 wherein said second magnetic core of said second connecting part comprises a second slab and two lateral legs, said lateral legs are vertically extended from edges of said second slab, said second winding is disposed between said lateral legs, and said second winding and said lateral legs are encapsulated by said second insulating enclosure, thereby defining said concave structure.

8. The connecting mechanism according to claim 2 wherein said first insulating enclosure has a first surface, and second insulating enclosure has a second surface aligned with said first surface.

9. The connecting mechanism according to claim 8 wherein said first magnetic core of said first connecting part comprises a first slab, a first center leg and two first lateral legs, said first center leg is vertically extended from a middle portion of said first slab, said first lateral legs are vertically extended from edges of said first slab, said first winding is disposed between said first center leg and said first lateral legs, and said first center leg, said first lateral legs and said first winding are sheltered by said first surface of said first insulating enclosure.

10. The connecting mechanism according to claim 8 wherein said second magnetic core of said second connecting part comprises a second slab, a second center leg and two second lateral legs, said second center leg is vertically extended from a middle portion of said second slab, said second lateral legs are vertically extended from edges of said second slab, said second winding is disposed between said second center leg and said second lateral legs, and said second center leg, said second lateral legs and said second winding are sheltered by said second surface of said second insulating enclosure.

11. The connecting mechanism according to claim 8 wherein said first magnetic core of said first connecting part comprises a slab, and said first winding is formed on said first magnetic core and sheltered by said first surface of said first insulating enclosure.

12. The connecting mechanism according to claim 8 wherein said second magnetic core of said second connecting part comprises a slab, and said second winding is formed on said second magnetic core and sheltered by said second surface of said second insulating enclosure.

13. The connecting mechanism according to claim 1 wherein when a first current outputted from said power adapter flows through said first winding of said first connecting part, a second current is magnetically induced by said second winding of said second connecting part and transmitted to said electronic device.

14. A connecting mechanism for connecting a power adapter and an electronic device, said connecting mechanism comprising:
a first connecting part connected with said power adapter, and comprising a first insulating enclosure and a first magnetic element, wherein said first magnetic element is disposed on said first insulating enclosure; and
a second connecting part connected with said electronic device, and comprising a second magnetic core, a second winding and a second magnetic element, wherein said first magnetic element and the second magnetic element are magnetically attracted by each other, so that said first connecting part is fixed onto said second connecting part.

15. The connecting mechanism according to claim 14 wherein a first magnetic core and a first winding are encapsulated within said first insulating enclosure, and a second magnetic core and a second winding are encapsulated within said second insulating enclosure, wherein electromagnetic coupling between said first winding and said second winding is produced.

16. The connecting mechanism according to claim 15 wherein when a first current outputted from said power adapter flows through said first winding of said first connecting part, a second current is magnetically induced by said second winding of said second connecting part and transmitted to said electronic device.

17. The connecting mechanism according to claim 15 wherein said first magnetic element is isolated from said first magnetic core and said first winding through said first insulating enclosure, and said second magnetic element is isolated from said second magnetic core and said second winding through said second insulating enclosure.
